(19) United States
(12) Patent Application Publication
(10) Pub. No.: US 2022/0063883 A1
(43) Pub. Date: Mar. 3, 2022

(54) SMART CONTAINER CAP WITH DIGITAL ACCESS AUTHENTICATION

(71) Applicant: Nicholas Evan Mott, San Jose, CA (US)

(72) Inventor: Nicholas Evan Mott, San Jose, CA (US)

(21) Appl. No.: 17/128,897

(22) Filed: Dec. 21, 2020

Related U.S. Application Data
(63) Continuation-in-part of application No. 15/946,734, filed on Apr. 6, 2018, now Pat. No. 10,870,517.

(51) Int. Cl. B65D 55/02; G07C 9/00; G08C 17/02; G01P 1/07; B65D 51/24; A61J 7/04

(52) U.S. Cl. CPC B65D 55/02; G07C 9/00309; G08C 17/02; G06K 9/00013; B65D 51/24; A61J 7/0409; G07C 2009/00325; G01P 1/07

(57) ABSTRACT

What is provided is a smart container cap device that can be unlocked remotely by a second device such as a smartphone or computer. The smart cap is sized and shaped to adhere to a standardized container lid sizing convention, such that the smart cap may be swapped for and replace a conventional container cap. The cap may also include sensors for detecting poor storage conditions (such as moisture or humidity) or tampering, or for a secondary means of granting access such as a biometric scan.

### CO-PENDING PATENT APPLICATION

This Nonprovisional patent application is a Continuation-in-Part patent application to Nonprovisional patent application Ser. No. 15/946,734 as filed on Apr. 6, 2018 by Inventor Nicholas Evan MOTT. Said Nonprovisional patent application Ser. No. 15/946,734 is hereby incorporated into its entirety and for all purposes into the present disclosure.

### FIELD OF THE INVENTION

The present invention pertains to the field of smart container closure mechanisms, and specifically to a container cap that can be remotely opened using a device such as a smartphone.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Selectively controlling access to containers is a longstanding and nontrivial concern, and has been ever since someone first built a box that could lock. There is a multitude of situations in which one would not want just anyone to be able to get into a given container, but wants also to still allow convenient authorized access.

As a few examples, childproofing of containers containing medicine, drugs, or cleaning chemicals has saved untold numbers of lives. Recent inventions of automatic pill dispensers that dispense medication when, and not before, the medicine should be taken have assisted people who need to precisely follow complicated medication regimens, even enabling care in situations where the person taking the medication wouldn't be able to follow written instructions as to when the medicine should be taken. As a further example, people living with mental illness often require regular meds to live functionally, but allowing unrestricted access to a full container or an early dose, even of a usual, needed, daily medication, may put the mentally ill individual in danger of self-poisoning.

While digital container-locking is known in the art, no single solution that works well for everyone has yet been engineered, nor have most people dealing with such situations adopted any solution more technologically sophisticated than a childproof cap, a high shelf, a lock on a cupboard door, or giving a dangerous container to a trusted individual to keep safe. Thus, there is a long-felt need to provide a more optimal solution.

### SUMMARY OF THE INVENTION

Towards these and other objects of the method of the present invention (hereinafter, “the invented method”) that are made obvious to one of ordinary skill in the art in light of the present disclosure, what is provided is a device that can fit in place of an ordinary container cap, which includes a control mechanism, sensors, a locking mechanism, and a wireless communications connection, such that the device may be remotely controlled by a second device such as a smartphone or computer to lock/unlock the container or report information from the sensors.

In most preferred embodiments, the invented device is a ‘smart cap’ that fits in place of and replaces a standard container cap, sealing the container (to at least the extent the regular cap did) and also providing additional features such as: (a.) remote-controlled unlocking via wireless communication, (b.) unlocking validation features such as a biometric scanner (allowing access in response to a recognized thumbprint or retina scan) or a keypad for entering a passcode, and also (c.) sensors inside the cap to safeguard the contents, such as moisture and/or humidity sensors that can send an alert via wireless if the contents of the container are in danger of getting ruined by moisture, or an accelerometer or impact sensor that may send an alert or otherwise register if someone should attempt to forcefully tamper with the container.

In most embodiments, the invented device fits in place of a cap or lid having a standardized size and shape, such as a prescription medicine bottle cap, a jar lid, or a gallon jug lid, to name only three examples of lids having well-known standardized shapes and sizes. Accordingly, the overall shape and size of the invented device may vary depending upon the cap size and shape standard being adhered to. Non-standard cap sizes and shapes are also included within the scope of the invention, but may be less useful (i.e. perhaps only slightly more useful than an ordinary cap that doesn't fit any available containers) without a container in mind that the cap is meant to fit onto. In preferred embodiments, the invented device is reusable and durable; a preferred application might be an instance of the invented device being installed onto one's current bottle of prescription medication, and this high-tech ‘favorite cap’ then being transferred onto a next bottle when the previous one is depleted. One might even provide a variety of invented caps having different decoration, such as colorful ones or ones with designs or patterns, or cap covers made of a more aesthetically-pleasing material such as glazed ceramic or carved wood, which may be a more practical investment for a consumer on an item meant to be reusable instead of single-use.

The invented cap, designed to restrict unauthorized access to the equipped container and allow authorized access, particularly access granted remotely, may allow more flexible and convenient storage of materials that can be unsafe if handled improperly, such as but not limited to medicine, chemicals, or sharp objects, or to which, for other reasons, restricted access is preferred. The cap may restrict access to the container by requiring a biometric scan, such as a thumbprint or retina, to match a preset one; may have a keypad and require a passcode; have a touch screen that can be programmed to require a certain authentication that can be entered via the touchscreen; or may be remotely operated by a device such as a computer or smartphone, allowing the sealed container to remain close to someone whose access should be limited but not allowing this person to actually access the contents until the container is unlocked by someone else who need not be present to do so. For instance, one might consider a situation in which a person needs regular medication, and a caregiver dispenses this medication to the person daily because it's unsafe for the person receiving the medication to have unsupervised access to the rest of the medicine, for whatever reason. The invented remotely controllable container cap would allow for a ‘cued up’ dose of medication, stored in a container protected by the invented cap, to be dispensed at the appropriate time (and not before) to the person who needs it, such as by the same caregiver operating the invented cap with a smartphone, without requiring the caregiver to be physically present just to ensure the medication is dispensed safely. The caregiver might still visit frequently, of course, but there is no emergency if the caregiver cannot be physically present to dispense a dose of medication.

A first preferred embodiment of the invented device is shaped to fit over the opening of a container, and may comprise: a cap enclosure with a cap cover and an inner body; a locking mechanism integrally combined with the cap enclosure; a smart module coupled with the cap enclosure and communicatively coupled locking mechanism, comprising a central processing unit (“CPU”), a wireless communications interface bi-directionally communicatively coupled with the CPU, wherein the memory contains instructions that operatively direct the device to: accept an open command as received by the wireless communications interface; and direct the locking mechanism to change to an open state upon receipt by the smart module of the open command.

In this preferred embodiment, the open command may be issued by a remote device operated by a user, and remote device is bi-directionally coupled with the smart module. In certain preferred embodiments, this remote device comprises a smart phone (e.g. an iPhone or Android). In other preferred embodiments, this remote device may comprise any network device, such as a smartphone, computer, laptop, or tablet.

This preferred embodiment may further include a biometric sensor (e.g. a thumbprint or retina scanner) communicatively coupled with the smart module, and the memory further containing a biometric pattern and additional instructions that operatively direct the device to: accept an open command when the biometric pattern is detected by the biometric sensor; and direct the locking mechanism to change to an open state when the biometric pattern is detected by the biometric sensor.

Additionally or alternatively, this embodiment might include a keypad coupled to the smart module, such that one can gain authorized access to the container by entering a passcode. The keypad might be numerical, alphanumerical, alphabetical, or even non-alphanumerical symbols and include any number of keys deemed to be appropriate to the application. The smart module would accept an ‘open’ command when the keypad receives the appropriate passcode or selection pattern, and direct the locking mechanism of the cap to unlock and allow access to the container.

Further, some preferred embodiments might include an electromagnetic actuator serving as the locking mechanism, operated by the smart module of the device. Additionally, certain preferred embodiments may have the cap cover shaped to provide a one way snap fit assembly between the cap enclosure and the inner body. Certain alternative preferred embodiments of the invented device may include sensors such as biometric, humidity, moisture, accelerometric, impact, tilting, or other sensors known in the art, communicatively coupled to the smart module to provide sensor information; a single invented cap may include multiple sensors, as deemed appropriate. Further, the invented cap or smartphone software may include a sensor reading threshold at which to alert a user, such as if the moisture or humidity might ruin the container contents, or if the accelerometer reading might indicate the container is being tampered with.

A moisture sensor and/or humidity sensor positioned on the inside of the invented cap may provide improved monitoring of the container contents. Depending on what these are expected to be, moisture or excessive humidity inside the container could be an indicator of conditions that could ruin the contents; this would provide an alert about that danger to the container contents without anyone even opening the container to check. An accelerometer, impact, tilting, or gyrometric sensor may provide an alert that the container is being tampered with, or has been tampered with, or that someone is trying to break into the container by force. It's known in the art of smartphones to detect a potential danger of impact trauma to a phone based on the accelerometer in the phone, because a sudden jump in speed may indicate that the phone has just slipped out of someone's hand; similarly, an accelerometer placed inside the invented cap may detect a container being broken into by means such as dropping of the container on a floor or surface, or throwing the container against a wall. An impact sensor, such as is known in the art for triggering the air bags in a car, might also detect tampering attempts an accelerometer might miss, such as an attempt to break into the container with a hammer. Tilting or gyroscopic sensors might be similarly useful for detecting attempts at unauthorized access, or even pointing out unsafe storage conditions, such as a container holding something seriously unpleasant to accidentally spill, such as a hazardous chemical, being stored on a shelf that wobbles or isn't level.

Further, the invented device may have one or more light emitters, such as LEDs, coupled with the smart module. These may be decorative or may provide signals, such as indicating that the cap is currently locked/unlocked or that a command or access attempt has been registered. The one or more light emitters may be any color, and may be just one color or more than one. In preferred embodiments, at least three colors of light may be available.

Further, the invented device may include a battery communicatively coupled to the smart module and configured to provide electrical energy as needed to support the functions of the device. This may be a replaceable or rechargeable battery, and the cap may further include means of charging if appropriate, such as an AC adapter, USB adapter, or small solar panel (like on a calculator), or other such means as known in the art.

The invented device includes a wireless communications interface in most preferred embodiments, and this interface may be in conformance with a wireless communications standard, such as Bluetooth, WiFi, NFC, or radio. A command to open may be transmitted by a remote device and received by the invented cap via the wireless communications interface, then executed by the smart module controlling the lock on the container.

The invented cap may be made of any suitable material known in the art, including but not limited to molded plastic, 3D-printed plastic, metal, wood, glass, ceramic, and so on. Concerns as to which material may be most suitable include that the cap be sufficiently durable and solid to deny access except by use of the means for digitally controlling the lock; that electrical elements as currently known in the art generally require conductive materials; and that decorative caps are very much possible but aesthetics may take a lower priority to security in most cases.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

The detailed description of some embodiments of the invention is made below with reference to the accompanying figures, wherein like numerals represent corresponding parts of the figures.

FIG. 1 is an overview diagram presenting the invented smart cap coupled with a container and operated by a device connected via a network.

FIG. 2A is a diagram presenting a view of the invented smart cap of FIG. 1 from above and to the side.

FIG. 2B is a diagram presenting a top view of the invented smart cap of FIG. 1.

FIG. 2C is a diagram presenting the invented smart cap of FIG. 1 in an exploded view.

FIG. 2D is a diagram presenting an underside view of the invented smart cap of FIG. 1.

FIG. 2E is a diagram presenting a side view of the invented smart cap of FIG. 1.

FIG. 2F is a diagram of the invented smart cap of FIG. 1, from below and to one side.

FIG. 2G is a diagram of the invented smart cap of FIG. 1, in an exploded view as viewed from below and to one side.

FIG. 2H is a diagram presenting a cutaway view of the invented smart cap of FIG. 1.

FIG. 2I is a diagram presenting a side view of the invented smart cap of FIG. 1, with the interior mechanisms visible.

FIG. 3A is a diagram presenting the one way snap fit assembly of the invented smart cap of FIG. 1 in a non-interlocked state wherein the cap cannot be opened.

FIG. 3B is a diagram presenting the one way snap fit assembly of the invented smart cap of FIG. 1 in an interlocked state wherein the cap can be opened.

FIG. 3C is a diagram demonstrating a turning direction of the cap of FIG. 1 for uncoupling with the container of FIG. 1.

FIG. 4A is a diagram presenting a side view of the invented smart cap of FIG. 1, with the interior mechanisms visible and in a disengaged position.

FIG. 4B is a detail from the diagram of FIG. 4A.

FIG. 4C is a diagram presenting a side view of the invented smart cap of FIG. 1, with the interior mechanisms visible and in an engaged position.

FIG. 4D is a detail from the diagram of FIG. 4B.

FIG. 5A is a diagram of the invented cap of FIG. 1 equipped with an alphanumeric keypad for controlling access.

FIG. 5B is a diagram of the invented cap of FIG. 1 equipped with a biometric sensor for controlling access.

FIG. 5C is a diagram of the invented cap of FIG. 1 equipped with a push-button for controlling access.

FIG. 5D is a diagram of the invented cap of FIG. 1 equipped with a touch-pad for controlling access.

FIG. 6 is a block diagram of the smart module of FIG. 2C.

FIG. 7 is a block diagram of the operating device of FIG. 1.

FIG. 8 is a flow chart regarding unlocking the cap, from the perspective of the invented smart cap of FIG. 1.

FIG. 9 is a flow chart regarding unlocking the cap, from the perspective of the operating device of FIG. 1.

FIG. 10 is a flow chart regarding gathering and transmitting sensor data, from the perspective of the invented smart cap of FIG. 1.

FIG. 11 is a flow chart regarding receiving and logging sensor data, from the perspective of the operating device of FIG. 1.

### DETAILED DESCRIPTION OF DRAWINGS

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Additionally, it should be understood that any transaction or interaction described as occurring between multiple computers is not limited to multiple distinct hardware platforms, and could all be happening on the same computer. It is understood in the art that a single hardware platform may host multiple distinct and separate server functions.

Throughout this specification, like reference numbers signify the same elements throughout the description of the figures.

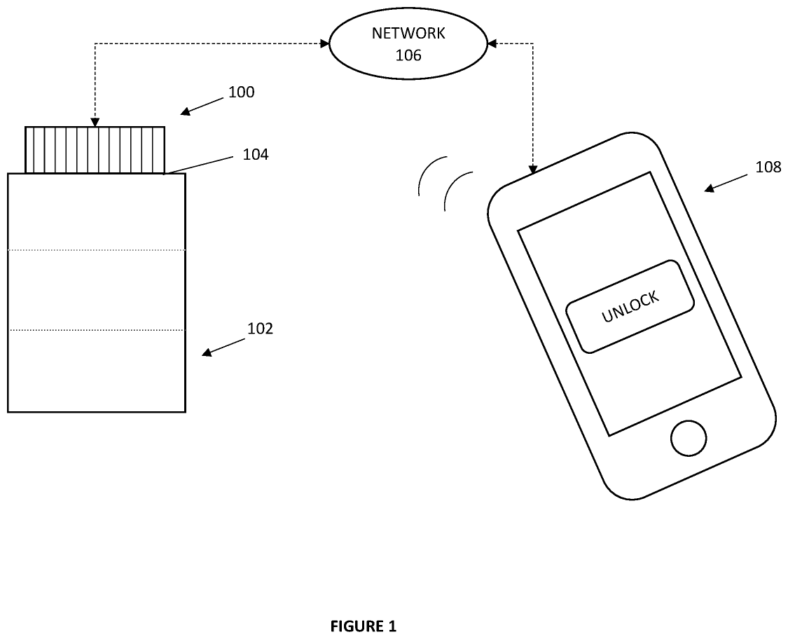

Referring now generally to the Figures and particularly to FIG. 1, FIG. 1 is an overview diagram presenting an invented smart cap 100 coupled to a container 102, sealing the container opening 104. the smart cap 100 can bidirectionally communicate with an electronic communications network 106, which is also connected to an operating device 108 such as a smart phone. In preferred embodiments and applications of the invention, a user (not shown) of the operating device 108 can use the operating device 108 to authorize access to the cap 100 via the network 106, thus controlling the cap 100 to unlock and permit uncoupling of the cap 100 from the container opening 104 and allowing access to the contents of the container 102. In preferred embodiments, the network 106 is wireless, and the communications taking place over this network follow a protocol such as WiFi, Bluetooth, or radio. Some preferred embodiments of the operating device 108 might include a computing device such as a smartphone, tablet, laptop computer, or desktop computer interacting with the smart module 202 via a software application, or a dedicated remote control device.

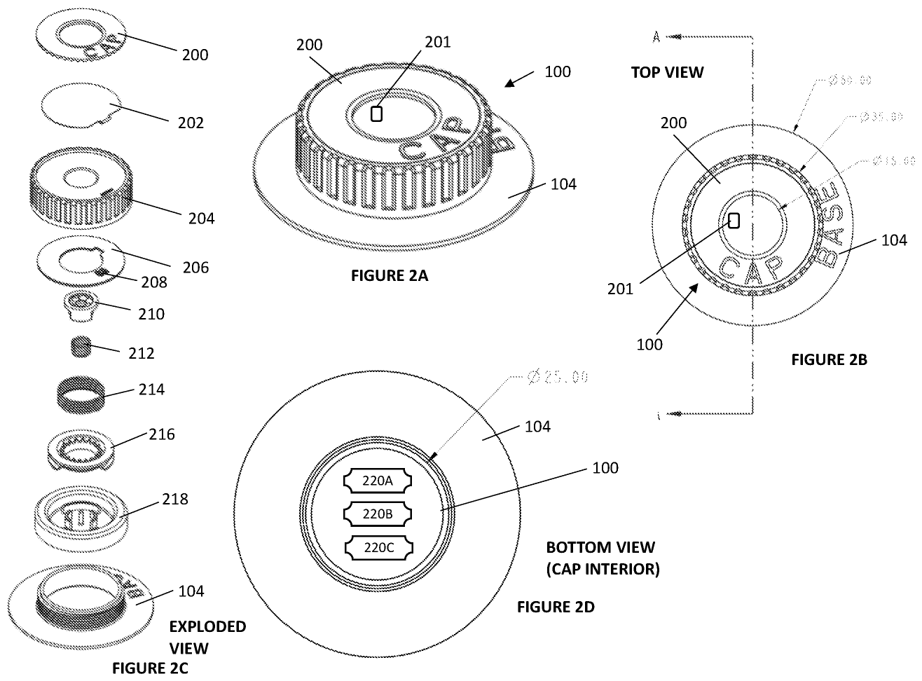

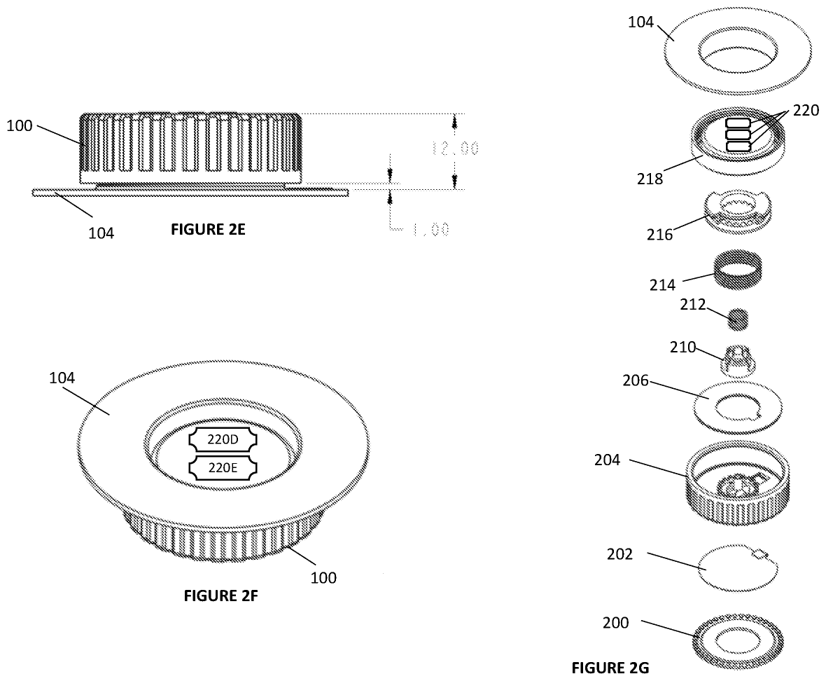

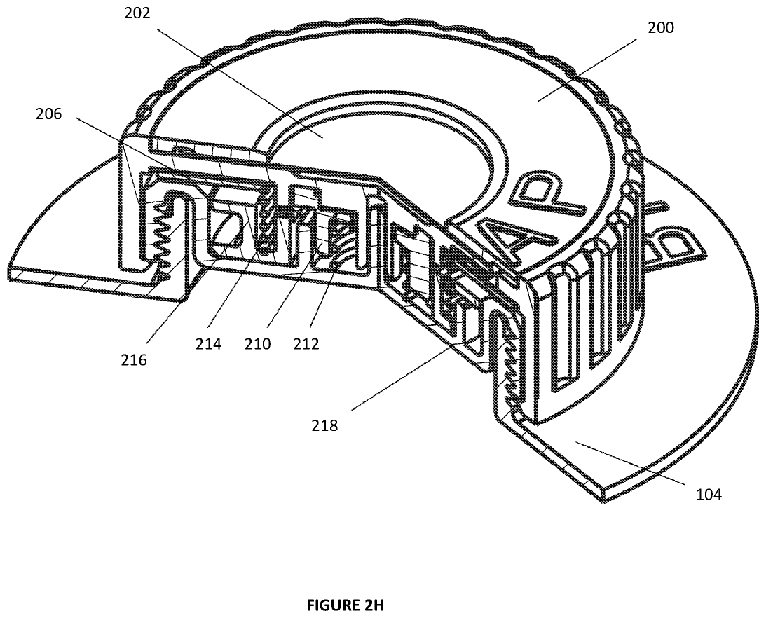

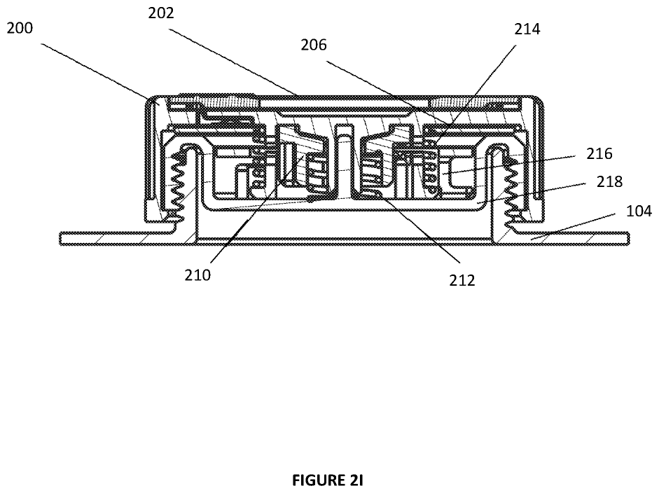

Referring now generally to the Figures and particularly to FIG. 2A, FIG. 2A is a diagram presenting a view of the invented smart cap of FIG. 1 from above and to the side. Throughout these Figures, the container opening 104 is frequently presented as shown here, with just the opening 104 and a portion of the adjacent container surface present, so that there is something for the cap 100 to ‘latch onto’, as though the opening 104 had been cut out of the top of the container 102. The opening 104 is not part of the invented cap 100, but presenting the opening 104 this way provides important context in showing how the cap 100 couples onto the container opening 104. An exterior element of the cap 100, namely a cap cover 200, is presented and labeled here and also in the exploded view of FIG. 2C. The exterior surface of the cap 100 may have one or more lights such as the LED 201 presented here. The LED(s) 201 may be simply decorative, or may provide information (such as indicating whether or not the cap is currently locked or conveying an alert), and may be in any single color or any variety of color.

Referring now generally to the Figures and particularly to FIG. 2B, FIG. 2B is a diagram presenting a top view of the invented smart cap of FIG. 1. This is a view of the invented cap 100 from directly above. While measurement labels may be present, the invention is not limited to these particular measurements as shown, and these might be considered an indication of preference in optimal manufacture.

Referring now generally to the Figures and particularly to FIG. 2C, FIG. 2C is a diagram presenting the invented smart cap of FIG. 1 in an exploded view. Presented here as separated pieces are: the cap cover 200, a smart module 202, a cap enclosure 204, an electromagnet 206, a pair of electromagnet electrodes 208, a close key 210, a close key spring 212, an open key spring 214, an open key 216, a threaded cap body 218, and the container opening 104.

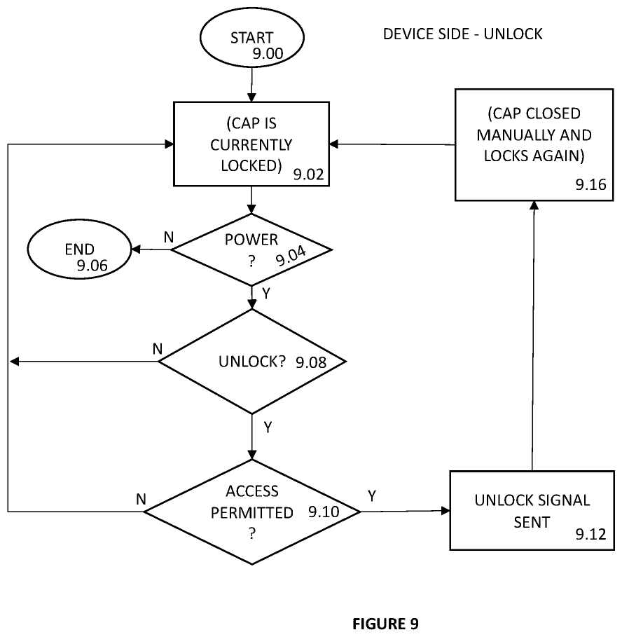

Functions of the cap cover 204 and cap enclosure 204 may include decoration; branding; environmental protection for the smart module 202; providing a watertight or airtight seal for the container 102; and providing a surface on which features such as the LED 201, a biometric sensor, a touch screen, a keypad, a button, or similar might be placed (see FIGS. 9A-9D). The cap cover 200 and/or cap enclosure 204 may each be made of any suitable material known in the art or discovered as suitable in the future, including but not limited to: polymers, plastics, rubber, elastomers, composites, ceramics, glass, metals, wood, fabric, or paper. The cap enclosure 204 is the part of the cap 100 a user might generally grip and turn when opening or closing the cap 100 mechanically.

The smart module 202 and electromagnet 206 are a printed circuit board assembly, and may comprise: (1.) a substrate such as composite, flexible materials, ceramics, or plastics, and (2.) metal coils and conductive elements forming the circuits of the board. The functions of the smart module 202 include: wireless connectivity (such as via WiFi, BlueTooth, RFID, infrared, or NFC), data logging, password or biometric protection, environment sensing and assessment, child safety features, position tracking, access records, key card access (such as by RFID/NFC, magnetic strip, embedded IC, or a QR code with an integrated camera module, and device settings. The functions of the electromagnet 206 include functioning as an actuator for toggling the cap 100 between locked and unlocked states and engaging and disengaging the open key 216 with the cap enclosure 204. The electromagnet 206 is communicatively connected to the smart module 202, and the smart module 202 controls the electromagnet 206 to toggle on and off.

The close key 210 is a one way turning key for closing the cap 100; when a user places the cap 100 onto the open container 102 and turns the cap 100 in order to close the container 102, the close key 210 is the element of the cap 100 that freely permits the cap 100 to be turned until sealed shut, but resists the cap 100 being turned back in the opposite direction to open the cap 100 the same way the cap 100 was just closed. Thus, once the cap 100 has been closed, the cap 100 is mechanically locked into remaining closed until opened by the appropriate unlocking method. The close key spring 212 maintains engagement between the cap enclosure 204 and the close key 210, such that a user gripping and moving the cap enclosure 204 can also move the close key 210 by doing so.

The open key 216 engages with the cap enclosure 204 when the cap 100 is unlocked for opening, such that the cap 100 can be moved or turned by a user gripping the cap enclosure 204. The open key spring 214 resets the open key position.

The close key 210 and open key 216 may be made of any suitable material known in the art or discovered to be suitable in the future, some examples of which include plastics, ceramics, metals, and wood. The close key spring 212 and open key spring 214 may be made of any suitable material known in the art or discovered to be suitable in the future, some examples of which include metals, plastics, rubber, and elastomers.

The threaded cap body 218 is shaped to be fastened to or unfastened from the container opening 104, such as including threading corresponding to threading of the container opening 104. The threaded cap body may be made of any suitable material known in the art or discovered to be suitable in the future, some examples of which include plastics, ceramics, metals, and wood.

Referring now generally to the Figures and particularly to FIG. 2D, FIG. 2D is a diagram presenting an underside view of the invented smart cap of FIG. 1. While measurement labels may be present, the invention is not limited to these particular measurements as shown, and these might be considered an indication of preference in optimal manufacture. Visible from this angle are a plurality of sensors 220, such as a humidity sensor 220A, a moisture sensor 220B, an accelerometer 220C, an impact sensor 220D of FIG. 2F, or a tilt sensor 220E of FIG. 2F, positioned on the underside of the cap 100, such as on the downward surface of the threaded cap body 218, such that when the cap 100 is coupled to a container 102, the sensors 220 are inside the container 102. It is noted that the cap 100 may include any one or more of these sensors 220, in any combination; in FIG. 2F, for instance, the sensors as presently shown are replaced with other options. While space constraints in these drawings prompt depiction of no more than three sensors 220 at a time, the number and placement of sensors 220 is not actually constrained this way. Herein, the sensors 220 are represented as little ‘patches’ on the underside of the cap 100; depending on models of sensors 220 available, this may or may not be the actual appearance of the sensors 220.

Referring now generally to the Figures and particularly to FIG. 2E, FIG. 2E is a diagram presenting a side view of the invented smart cap of FIG. 1. While measurement labels may be present, the invention is not limited to these particular measurements as shown, and these might be considered an indication of preference in optimal manufacture.

Referring now generally to the Figures and particularly to FIG. 2F, FIG. 2F is a diagram of the invented smart cap of FIG. 1, from below and to one side. In this image, the sensors 220 represented are instead an impact sensor 220D and a tilt sensor 220E. The sensors 220 may include any or all of the varieties of sensors 220 listed herein.

Referring now generally to the Figures and particularly to FIG. 2G, FIG. 2G is a diagram of the invented smart cap of FIG. 1, in an exploded view as viewed from below and to one side.

Referring now generally to the Figures and particularly to FIG. 2H, FIG. 2H is a diagram presenting a cutaway view of the invented smart cap of FIG. 1, with interior mechanisms visible as labeled.

Referring now generally to the Figures and particularly to FIG. 2I, FIG. 2I is a diagram presenting a cutaway side view of the invented smart cap of FIG. 1, with interior mechanisms visible as labeled.

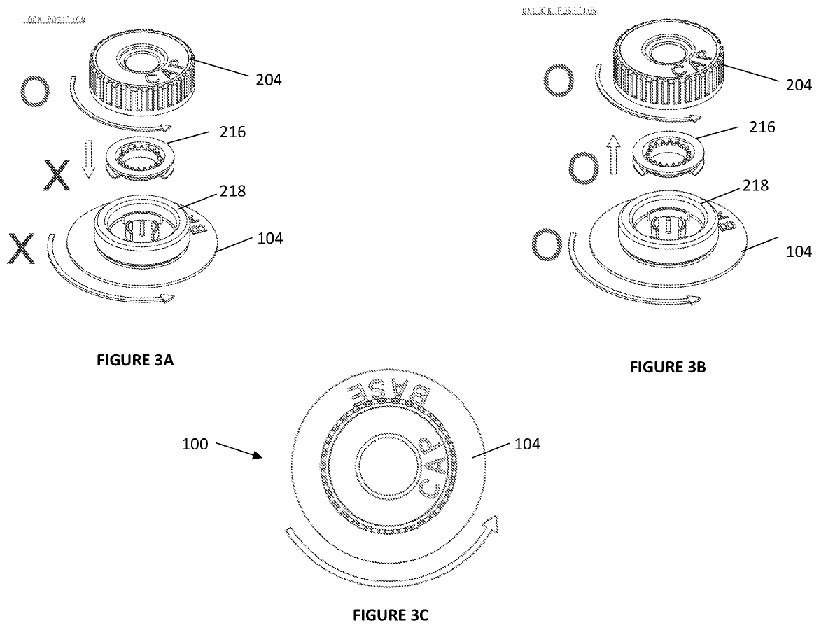

Referring now generally to the Figures and particularly to FIG. 3A, FIG. 3A is a diagram presenting the one way snap fit assembly of the invented smart cap of FIG. 1 in a non-interlocked state wherein the cap cannot be opened.

Referring now generally to the Figures and particularly to FIG. 3B, FIG. 3B is a diagram presenting the one way snap fit assembly of the invented smart cap of FIG. 1 in an interlocked state wherein the cap can be opened.

Referring now generally to the Figures and particularly to FIG. 3C, FIG. 3C is a diagram presenting the cap 100 being opened by a counterclockwise turning motion, as commonly known in the art. It is understood that the cap 100 could just as well be designed to open when turned clockwise instead, but this would be likely to confuse or frustrate a majority of users, who are used to tightening a cap by turning the cap to the right (clockwise), and loosening by turning the cap to the left (counterclockwise). In FIGS. 3A through 3C, the cap 100 is turned counterclockwise; however, in FIG. 3A, the internal mechanism of the cap 100 is disengaged, such that while the cap enclosure 204 is turned, the cap 100 remains in place because the threaded cap body 218, which attaches to the container opening 104, does not turn along with the cap enclosure 204. Thus, the cap 100 remains locked.

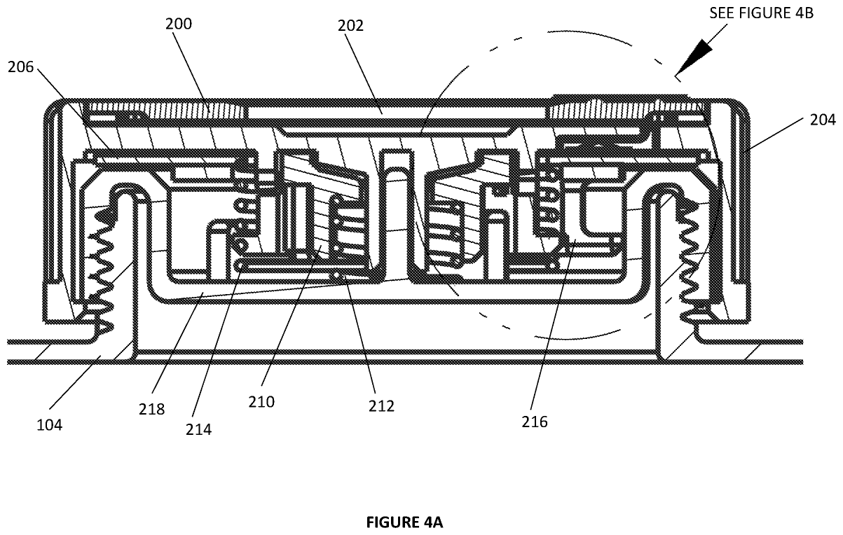

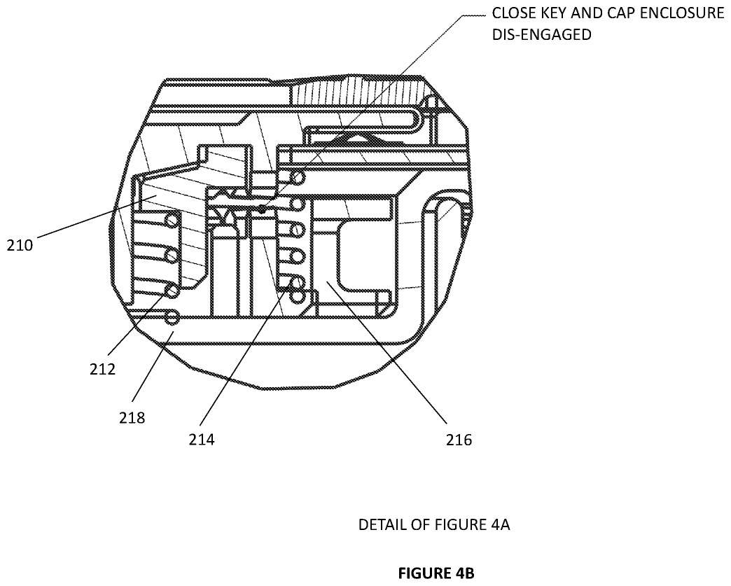

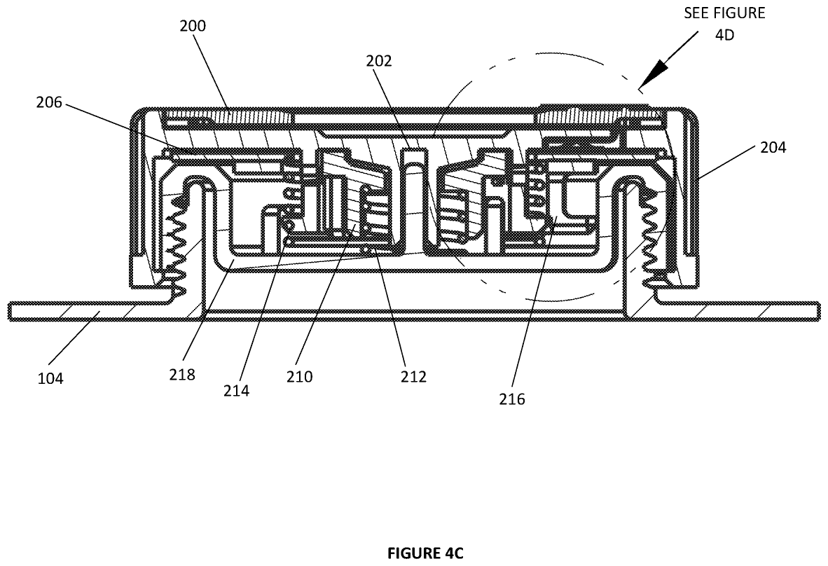

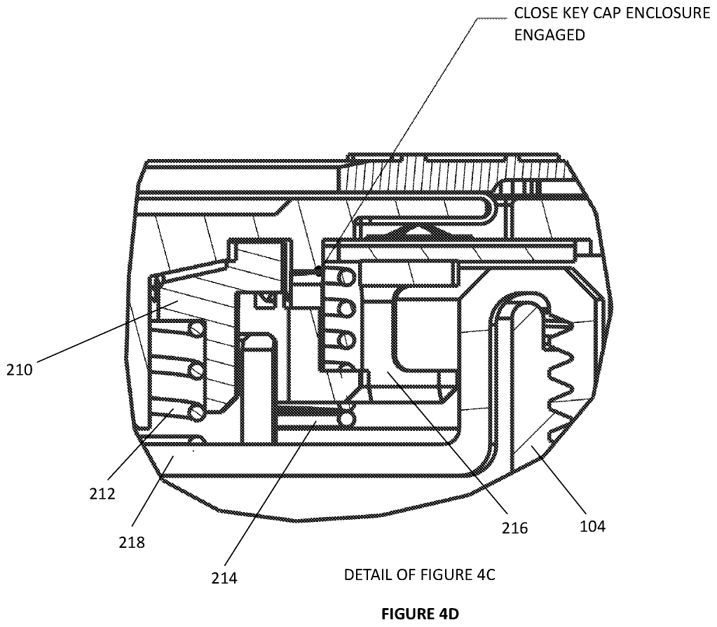

Referring now generally to the Figures and particularly to FIG. 4A, FIG. 4A is a diagram presenting a side view of the invented smart cap of FIG. 1, with interior mechanisms visible as labeled and presented in the disengaged position of FIG. 3A.

Referring now generally to the Figures and particularly to FIG. 4B, FIG. 4B is a detail from the diagram of FIG. 4A, as defined by the circle of FIG. 4A. While measurement labels may be present, the invention is not limited to these particular measurements as shown, and these might be considered an indication of preference in optimal manufacture.

Referring now generally to the Figures and particularly to FIG. 4C, FIG. 4C is a diagram presenting a side view of the invented smart cap of FIG. 1, with the interior mechanisms visible and in the engaged position of FIG. 3B.

Referring now generally to the Figures and particularly to FIG. 4D, FIG. 4D is a detail from the diagram of FIG. 4B, as defined by the circle of FIG. 4C. While measurement labels may be present, the invention is not limited to these particular measurements as shown, and these might be considered an indication of preference in optimal manufacture.

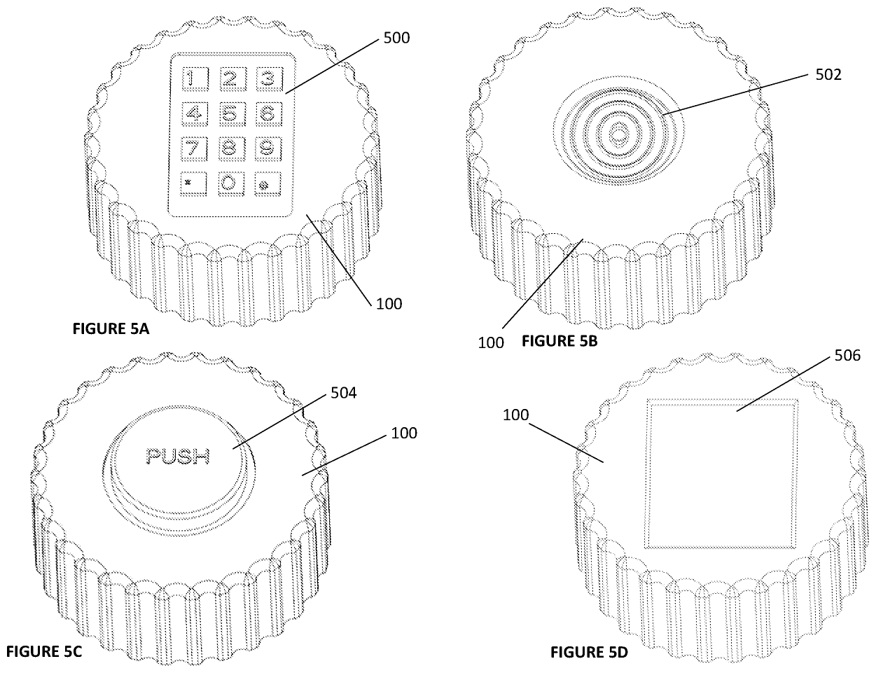

Referring now generally to the Figures and particularly to FIG. 5A, FIG. 5A is a diagram of the invented cap of FIG. 1 equipped with an alphanumeric keypad 500 for controlling access. In a preferred embodiment, the smart module 202 controls the cap 100 to open in response to a user pressing a plurality of keys in a preset sequence such as an access code. All means of authentication disclosed herein may be used individually or in combination with any or all other means of authentication as deemed appropriate; for instance, one might be required to enter a code in order to request authorization from a remote device, providing a form of two-factor authentication.

Referring now generally to the Figures and particularly to FIG. 5B, FIG. 5B is a diagram of the invented cap of FIG. 1 equipped with a biometric sensor 502 for controlling access. In a preferred embodiment, the smart module 202 controls the cap 100 to open in response to input via the biometric sensor 502 of a preset biometric input reading such as a particular recognized thumbprint or retina pattern.

Referring now generally to the Figures and particularly to FIG. 5C, FIG. 5C is a diagram of the invented cap of FIG. 1 equipped with a push-button 504 for controlling access. In a preferred embodiment, the smart module 202 allows opening of the cap 100 in response to input comprising or including pushing of the push-button 504. This embodiment may be useful in a situation where the primary user of the container 102 need not be locked out of the container 102, but rather may have difficulty operating a standard cap for whatever reason. Additionally, in a case where control of access is necessary, the push-button 504 may be a means to request access remotely, such as by sending a request for access to the operating device 108 when the push-button 504 is pressed, prompting a second user holding the operating device 108 to either ignore the request or open the container 102 as requested. The push-button 504 may be any size or shape.

Referring now generally to the Figures and particularly to FIG. 5D, FIG. 5D is a diagram of the invented cap of FIG. 1 equipped with a touch-pad 506 for controlling access. This may be an authentication mechanism requiring a specific input, such as a pattern drawn by a fingertip, or may be an accessibility assist that allows a user to open the cap by digital, rather than the usual mechanical, means. This may also be a small display screen that one can select options on, such as programming allowed authentication inputs or similar settings options for operating the smart cap 100, or optionally may be suitable for running software applications, such as setting a timer or alarm for reminders about dosage timing.

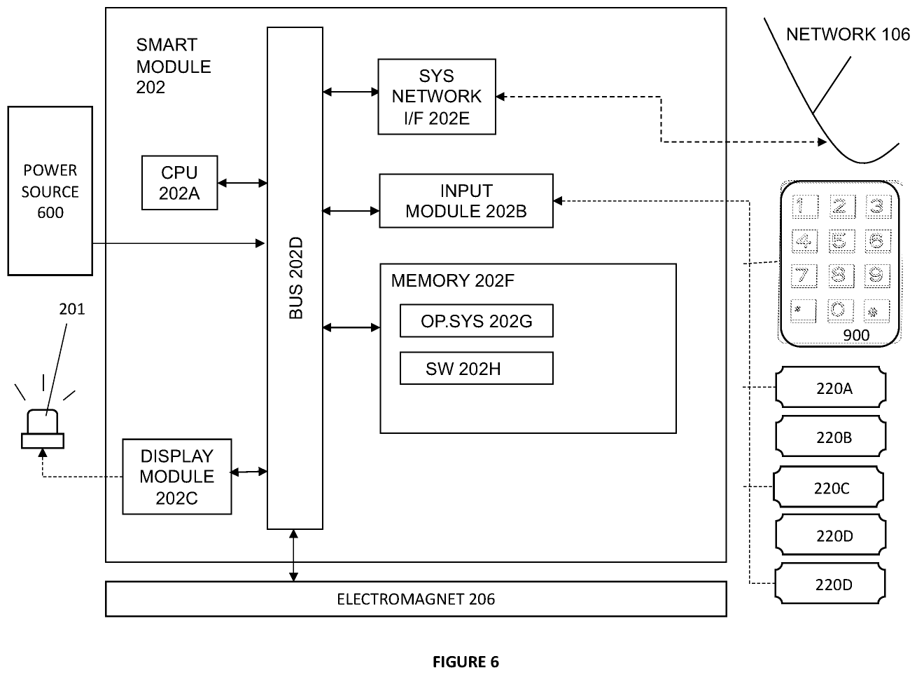

Referring now generally to the Figures and particularly to FIG. 6, FIG. 6 is a block diagram of a possible implementation of the smart module 202 of FIG. 2C, as connected to the network 106 of FIG. 1 and displaying together both hardware and software aspects thereof, wherein the smart module 202 may comprise: a central processing unit (“CPU”) 202A; a user input module 202B; a display module 202C; a software bus 202D bi-directionally communicatively coupled with the CPU 202A, the user input module 202B, the display module 202C; the software bus 202D is further bi-directionally coupled with a network interface 202E, enabling communication with alternate computing devices by means of the network 106; and a memory 202F which may include software such as an operating system 202G or other software 202H. The software bus 202D facilitates communications between the above-mentioned components of the smart module 202. The input module 202B of the smart module 202 may further include communicative connections to input modules such as the internal sensors 220, and/or access mechanisms or sensors located on top of the cap 100 such as the keypad 500, the biometric sensor 502, the push button 504, or the touch screen 506. The smart module 202 may additionally include a connection to a power source 600, such as for example a battery, a small solar panel atop the cap 100 (like on a pocket calculator), or means for generating and storing power from received network signals, to enable function of the smart module 202. The display module 202C may further include communicative connection(s) to elements such as the LED(s) 201 or the visual display of the touch screen 506. The smart module 202 is further communicatively coupled to the electromagnet 206, such that upon receiving valid input for directing the cap 100 to open, the smart module 202 controls the electromagnet 206 to permit opening of the cap 100. It is understood that the presented configuration is only one example of a suitable hardware/software device for implementing the functionality of the invented cap 100 as presented herein, and any smart module 202 design capable of providing the computer functionality presented herein is suitable, including a simpler electronic circuit or similar if appropriate. The exemplary device software program SW 202H consisting of executable instructions and associated data structures is optionally adapted to enable the smart module 202 to (a.) direct the cap 100 to unlock in response to appropriate input; (b.) assess and distinguish appropriate input, and store information relevant to determining whether input is appropriate; (c.) operate the sensors 220 and log or transmit data as directed; and (d.) to perform, execute and instantiate all elements, aspects and steps as required of the smart module 202 to practice the invented method in its various preferred embodiments.

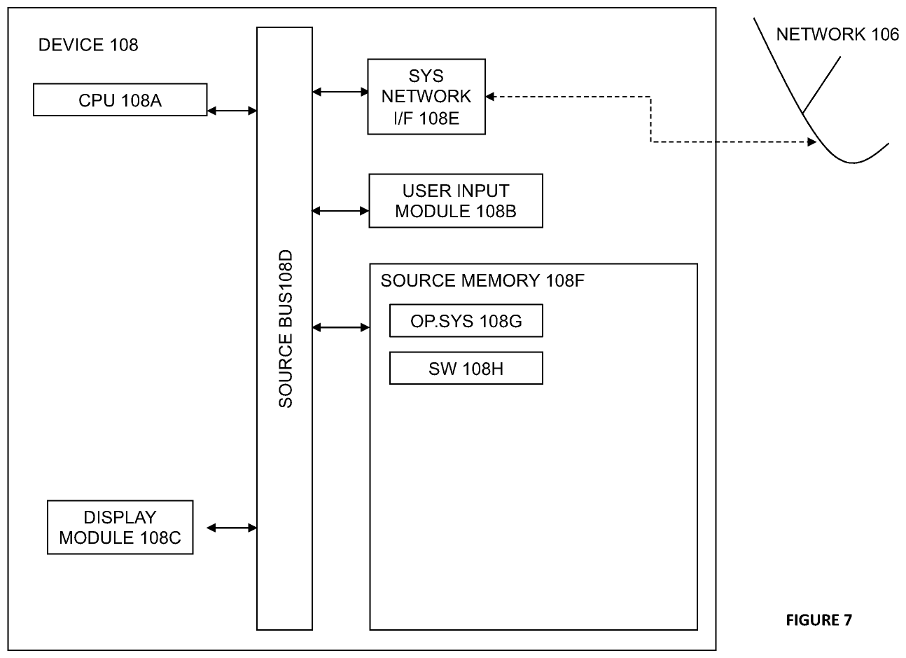

Referring now generally to the Figures and particularly to FIG. 7, FIG. 7 is a block diagram of the operating device 108 of the network 106 of FIG. 1 and displaying together both hardware and software aspects thereof, wherein the device 108 comprises: a central processing unit (“CPU”) 108A; a user input module 108B; a display module 108C; a software bus 108D bi-directionally communicatively coupled with the CPU 108A, the user input module 108B, the display module 108C; the software bus 108D is further bi-directionally coupled with a network interface 108E, enabling communication with alternate computing devices by means of the network 106; and a memory 108F. The software bus 108D facilitates communications between the above-mentioned components of the device 108.

Alternatively, optionally and/or additionally the device 108 and its functions as disclosed in the present disclosure are wholly or in part are comprised within, provided within, and/or made accessible via, or directly or indirectly via the network 106, including but not limited to a Virtual Machine and/or Platform as a Service, including but not limited to an Amazon Web Services (AWS) asset, a Microsoft Cloud (Azure) asset or service, a Google Cloud service or asset, and Oracle Cloud Infrastructure (OCI) asset or service, and/or one or more suitable internet-accessible assets or services in singularity, in concert or in combination.

The memory 108F of the device 108 includes a software operating system OP.SYS 108G. The software OP.SYS 108G of the device 108 may be selected from freely available, open source and/or commercially available operating system software, to include but not limited to IBM Power System 5924 marketed by IBM, or Dell EMC PowerEdge™ Servers; or (d.) other suitable computational system or electronic communications device known in the art capable of providing networking and operating system services as known in the art capable of providing networking and operating system services as known in the art. The exemplary device software program SW 108H consisting of executable instructions and associated data structures is optionally adapted to enable the device 108 to (a.) provide an interface for operating the cap 100; (b.) transmit a signal directing the cap 100 to open; (c.) receive and store sensor data from the cap 100 as gathered by one or more cap sensors 220; and (d.) to perform, execute and instantiate all elements, aspects and steps as required of the device 108 to practice the invented method in its various preferred embodiments in interaction with the smart module 202 of the cap 100.

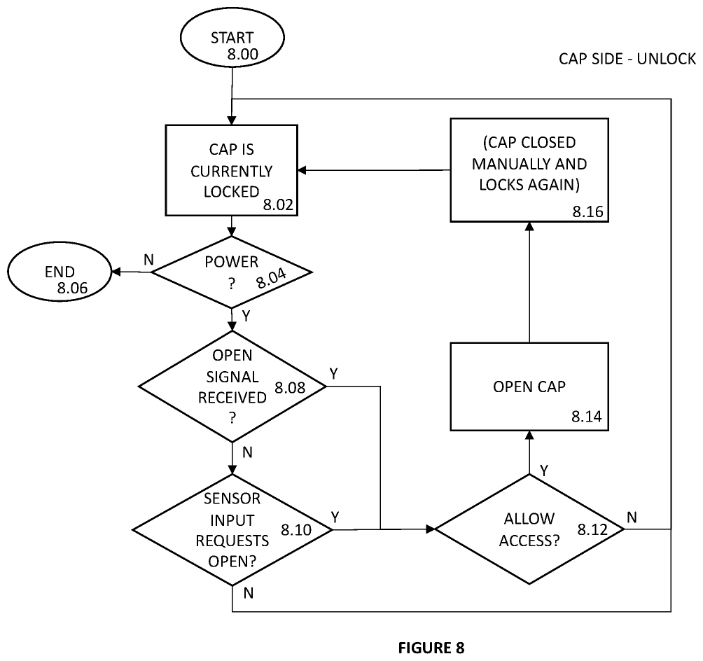

Referring now generally to the Figures and particularly to FIG. 8, FIG. 8 is a flow chart regarding unlocking the cap, from the perspective of the invented smart cap of FIG. 1. In step 8.00, the process starts. In step 8.02, the cap 100 is currently in a closed and locked position. In step 8.04, there is a check for the end of an otherwise endless loop; if the smart module 202 is ever unpowered, the process may end at step 8.06 at least until power is restored. At step 8.08, the smart module 202 may receive a signal from the operating device 108 to open the cap 100; alternatively, at step 8.10, input may be received from the sensor inputs of the cap 100, such as the biometric sensor 502 or keypad 500. If any input requesting access to the cap 100 is received, the smart module 202 determines at step 8.12 whether the input is valid. The signal may be from an unauthorized device 108; the keypad 500 code may be incorrect, or the thumbprint scan from the biometric sensor 502 may not be an authorized thumbprint. Or, something may have hit a keypad key by accident. If the smart module 202 assesses that the input is invalid, the cap 100 remains closed. If the smart module 202 assesses that the input is valid, at step 8.14 the smart module 202 controls the electromagnet 208 to open the cap 100. The cap 100 remains open until manually replaced on the container opening 104 and resealed at step 8.16. This action is done manually, not controlled by the smart module 202, hence the parentheses in step 8.16. Once the cap 100 is closed again, the process repeats, awaiting a next input.

Referring now generally to the Figures and particularly to FIG. 9, FIG. 9 is a flow chart regarding unlocking the cap 100, from the perspective of the operating device 108 of FIG. 1. In step 9.00, the process starts. In step 9.02, the cap 100 is currently locked. Step 9.04 checks for an end to an otherwise endless loop; if the device 108 is ever unpowered, the process ends at step 9.06 at least until power is restored. In step 9.08, a user has the option of directing the cap 100 to unlock. If the user elects not to, the cap 100 remains locked. If the user directs the cap 100 to open, there may be an authentication step, such as entering a password code on the operating device 108, at step 9.10. Even if the smart module 202 also may authenticate a signal received at step 8.12, the smart module 202 is ensuring that the signal came from an authorized device 108 (e.g. making sure that the network ‘handshake’ is being done with a recognized device, and that this isn't a random unrelated signal or attempt to circumvent the security with a different device), while the device 108 is ensuring at step 9.10 that the user requesting the unlock is authorized to operate the device 108 in that capacity in the first place. It is understood that the layers of authentication available may vary depending on security needs weighed against convenience. If the device 108 assesses the unlock request to be valid, the device 108 transmits a signal to the smart module 202 of the cap 100, directing the smart module 202 to unlock the cap. The cap 100 remains open until manually closed again, at which point the cap 100 is once again locked, and may once again be unlocked by the process herein.

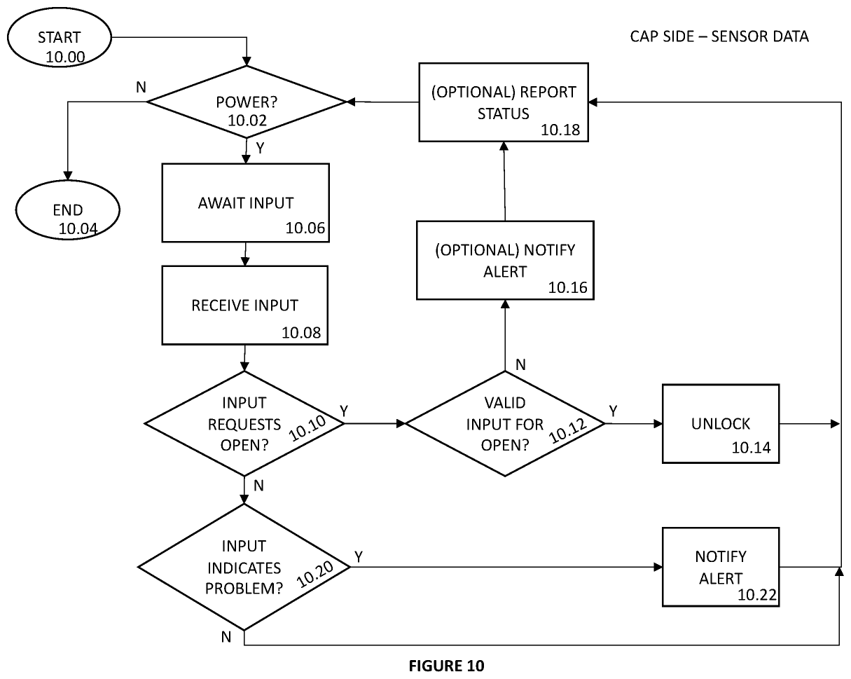

Referring now generally to the Figures and particularly to FIG. 10, FIG. 10 is a flow chart regarding gathering and transmitting data from input devices, from the perspective of the invented smart cap of FIG. 1. In this context, the term “input devices” is used to refer collectively to the sensors 220 and also to external input devices such as the keypad 500, biometric sensor 502, push-button 504, and/or touch pad 506. It is noted that, depending on particular embodiment of the cap 100, there may be more or fewer input devices, the input devices may vary, or there may even be none at all, such as embodiments where the cap 100 opens solely by receiving a digital signal over the network 106 and has no sensors 220; this process may only be relevant to the extent the cap 100 includes input devices. At step 10.00, the process starts. At step 10.02, there is a check for the end of an otherwise endless loop; if the smart module 202 is unpowered, the process may end at step 10.04 at least until power is restored. It is noted that depending on available system settings for the smart module 202, some or all input devices may be disabled; this case could also be considered a halt to this process, or, though potentially less efficiently, as a ‘null’ version of the process wherein the answers to steps 10.10 and 10.20 are always No. In step 10.06, the smart module 202 awaits input. In step 10.08, the smart module receives input from an input device. In step 10.10, there is a check as to whether the input is a request to open the cap 100, such as the input of a thumbprint on the biometric sensor 502, or some other kind of input, such as something picked up by the sensors 220. If the input is a request to open the cap, then in step 10.12, the smart module 202 determines whether the input is valid; if a thumbprint on the biometric sensor 502 (as only one example), is this recognized as a permitted thumbprint for opening the cap 100? If so, then the smart module 202 opens the cap 100 at step 10.14. If the access validation is unsuccessful in step 10.12, depending on the security level preferred, the smart module 202 may optionally trigger flashing LED(s) 201 or a noisy alarm (if the cap 100 is equipped with a sound-emitting device) or transmit a warning to an operating device 108 in step 10.16 that an unauthorized individual is attempting to access the container. Regardless of whether the cap 100 was successfully opened, the smart module 202 may optionally be configured to report a current status to the operating device 108, such as whether the cap 100 is currently open or closed, what the input devices are currently registering, and so on. If the operating device 108 maintains a log over time, it would be possible to provide additional features such as keeping track of when the cap 100 was last opened or closed; whose thumbprint, device 108, or code was used to open the cap 100 most recently; and maintain an ongoing history of input device readings. With this kind of remote support, the smart module 202 need only provide regular updates of current status, rather than store such information in the smart module memory 202F. This seems like the optimal option, though an embodiment wherein the smart module 202 includes the memory 202F and CPU 202A to keep such a record locally may also be preferred, particularly in an embodiment less dependent on the operating device 108. In step 10.20, having determined that the input is not a request for opening the cap 100, the smart module 202 next determines whether the input being received indicates something that should be reported urgently instead of simply logged as data. Some examples might be sensor input data that indicates an attempt at tampering with the container 102, such as a high reading on the accelerometer 220C; or a reading that indicates that the container 102 is not a safe environment for the container contents, such as an excessively high moisture or humidity reading inside the same container 102 as medicine that should be kept dry. The cap 100 may include sensors 220 that detect an incomplete seal on the container 102, or that the container 102 has been accidentally left ajar. Use of the invented cap 100 in, for instance, a scientific or industrial environment, could be beneficial to include in safety practices, and provide additional detection of a container 102 containing hazardous or volatile material being left unexpectedly unsealed. Such ‘alert conditions’ might be set in system settings for the smart module 202 or operating device 108, such that if or when a certain sensor input is detected, such as the examples above, the cap 100 or the operating device 108 (or both) provides an alert to a user. Locally on the smart module 202, this notification of an alert condition at step 10.22 may take the form of causing the LED(s) 201 to flash, or causing the cap 100 to emit a noise such as beeping or buzzing, if the smart module 202 is equipped to do so. This local warning might warn anyone standing near the container 102 that something isn't right, such as in the case of a container 102 full of hazardous gas being ajar and requiring people to immediately vacate the room for their own safety, or, less dramatically, this may simply prompt someone who just closed the cap 100 to ‘try again’ because the cap 100 was not closed properly. Additionally, the cap may also optionally transmit an alert to the operating device 108. Regardless of whether the input was alert-triggering or merely another point on a graph, the input may subsequently be optionally logged or reported, as discussed above regarding step 10.18.

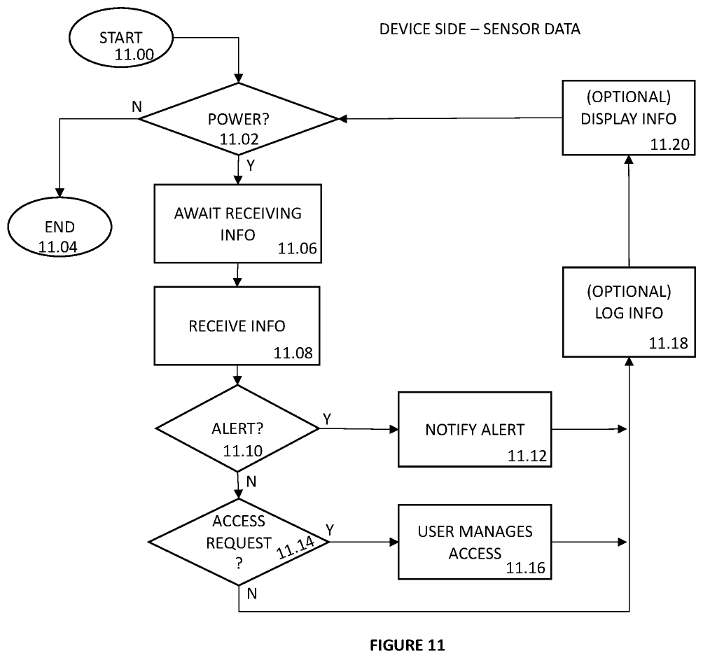

Referring now generally to the Figures and particularly to FIG. 11, FIG. 11 is a flow chart regarding receiving and logging input data, from the perspective of the operating device of FIG. 1. This may be considered as a ‘mirroring’ flow chart to FIG. 10, presenting the device 108 side in which data transmitted by the smart module 202 is received and acted upon by the device 108. In step 11.00, the process starts. Step 11.02 provides a check for halting this otherwise endless loop; if the device 108 is unpowered, the process may cease at step 11.04 at least until power is restored. It is additionally noted that some input devices may or may not be present depending on the embodiment of cap 100, and the device 108 would only be receiving data regarding input devices the cap 100 includes. In step 11.06, the device 108 awaits transmitted data from the cap 100. In step 11.08, the device 108 receives a transmission of data from the cap 100. In step 11.10, it is determined whether the data received is an alert or is a data value that triggers an alert response; please see the discussion above in FIG. 10 regarding some examples of alert conditions. The cap 100 may itself register an alert condition, and respond by flashing LED(s) 201, beeping, or transmitting an alert message to the device 108; the device 108 may also determine an alert condition from received data regardless of what the cap 100 itself does. The device 108 may register an alert by producing a notification, pop-up window, or customized data display on the device 108 interface; by sending a message such as a text or email to a preset recipient; by producing an animation, a screen flash, a noise, or an alarm; by activating another compatible hardware device; or any other means known in the art for a computing device such as a smartphone, laptop, or desktop computer to get a user's attention or otherwise respond to received input in a pre-programmed fashion. If the data is not cause for alarm, in step 11.14 the data may be a request for the device 108 user to grant access to the container 102, such as in a situation where the invented cap 100 provides ‘two-factor authentication’ for dispensing medication safely, such that someone near the container 102 may push the push-button 504 to indicate readiness to open the container 102, and the holder of the device 108 receives a prompt to allow access if appropriate. In step 11.16, the user of the device 108 is provided with an interface means to allow or deny access in response to the request, such as a button to click or tap. Optionally, the user of the device 108 may also be required to provide authentication, such as a password, passcode, fingerprint, or other means known in the art by which a computing device such as a smartphone, laptop, or desktop computer might verify user authorization. In step 11.18, the device 108 may optionally record or log the information received, such as to maintain a history of sensor data or user interactions with the cap 100. in step 11.20, the device 108 may also display the received information for a user, such as to provide regular status updates or provide current status upon request. It is noted that these steps are not necessarily restricted to the order in which the steps appear here; an access request may be checked for prior to an alert; data may be logged before being analyzed for alerts or requests; and an information display for a user might be displayed at any time, even while new information is being added.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. A device shaped to fit over the opening of a container, the device comprising:
a cap enclosure with a cap cover and an inner body;
a locking mechanism integrally combined with the cap enclosure;
a smart module coupled with the cap enclosure and communicatively coupled locking mechanism, comprising a central processing unit (“CPU”), a wireless communications interface bi-directionally communicatively coupled with the CPU, wherein the memory contains instructions that operatively direct the device to:
accept an open command as received by the wireless communications interface; and
direct the locking mechanism to change to an open state upon receipt by the smart module of the open command.

2. The device of claim 1, wherein the open command is issued by a remote device operated by a user, and remote device is bi-directionally coupled with the smart module.

3. The device of claim 2, wherein the remote device comprises a smart phone.

4. The device of claim 2, wherein the remote device comprises a network device.

5. The device of claim 1, wherein the device further comprises a biometric sensor communicatively coupled with the smart module, and the memory further contains a biometric pattern and additional instructions that operatively direct the device to:
accept an open command when the biometric pattern is detected by the biometric sensor; and
direct the locking mechanism to change to an open state when the biometric pattern is detected by the biometric sensor.

6. The device of claim 1, wherein the device further comprises a keypad communicatively coupled with the smart module, and the memory further contains a keypad selection pattern and additional instructions that operatively direct the device to:
accept an open command when the keypad selection pattern is received via the keypad; and
direct the locking mechanism to change to an open state when the stored keypad selection pattern is received via the keypad.

7. The device of claim 1, wherein the locking mechanism comprises an electromagnetic actuator operatively controlled by the smart module.

8. The device of claim 1, wherein the cap cover is shaped to provide a one way snap fit assembly between the cap enclosure and the inner body.

9. The device of claim 1, further comprising a sensor communicatively coupled with the CPU.

10. The device of claim 9, wherein the sensor detects humidity within the inner body.

11. The device of claim 9, wherein the sensor detects moisture within the inner body.

12. The device of claim 9, wherein the sensor is an accelerometer.

13. The device of claim 12, wherein the memory further contains a threshold value and additional instructions that operatively direct the device to report a detection by the accelerometer of motion above the threshold value to a remote device via the wireless communications interface.

14. The device of claim 1, the smart module further comprises a light emitter coupled with the CPU.

15. The device of claim 14, wherein the light emitter is configured to present at least three light emitting color states.

16. The device of claim 15, wherein the device further comprises:
a. an accelerometer communicatively coupled with the CPU; and
b. a threshold value and additional instructions stored in the memory that operatively direct the device to alter the color state of the light emitter upon a detection by the accelerometer of motion above the threshold value.

17. The device of claim 1 further comprising a battery coupled with the smart module and configured to provide electrical energy to the smart module.

18. The device of claim 1, wherein the wireless communications interface is in conformance with a wireless communications standard.

19. The device of claim 18, wherein the wireless communications standard is selected from the group of standards consisting of the Bluetooth standard, the WiFi standard and the NFC standard.

20. The device of claim 18, wherein the open command is issued by a remote device operated by a user, and remote device is bi-directionally coupled with the smart module transmits the open command in conformance with the wireless communications standard.

21. The device of claim 9, wherein the sensor is an impact sensor.

22. The device of claim 9, wherein the sensor is a tilt sensor.
